(19) United States
(12) Patent Application Publication
(10) Pub. No.: US 2017/0271756 A1
(43) Pub. Date: Sep. 21, 2017

(54) CONNECTOR, BUILT-IN ANTENNA STRUCTURE AND UNMANNED AERIAL VEHICLE

(71) Applicant: ZEROTECH (Chongqing) Intelligence Technology Co., Ltd., Chongqing (CN)

(72) Inventors: YUCHENG LIANG, Beijing (CN); FUHUA AI, Beijing (CN)

(21) Appl. No.: 15/407,947

(22) Filed: Jan. 17, 2017

(30) Foreign Application Priority Data
Mar. 21, 2016 (CN) 201620218518.7

(51) Int. Cl. H01Q 1/28; B64C 25/52; H01Q 1/18; H01Q 1/12; H01Q 3/04; B64C 39/02; B64D 47/00

(52) U.S. Cl. CPC H01Q 1/288; B64C 39/024; B64C 25/52; B64D 47/00; H01Q 1/1242; H01Q 1/1221; H01Q 3/04; H01Q 1/18; B64C 2201/146

(57) ABSTRACT

A connector, a built-in antenna structure, and an unmanned aerial vehicle using the built-in antenna structure. The unmanned aerial vehicle includes a body, and a support stand including a receiving rod. The built-in antenna structure includes a connector, a buffer and an antenna. The antenna and the buffer are received in the receiving rod, with the buffer wrapping the antenna. The connector is disposed between the receiving rod and the body to drive the receiving rod to rotate relative to the body. One end of the antenna protrudes from the connector and is electrically connected with the body. In an embodiment, the space occupied by the antenna is reduced, and the service life of the antenna and the overall appearance of the unmanned aerial vehicle are improved. Moreover, the angle of the receiving rod can be adjusted, for facilitating reception of signals by the antenna.

### CROSS-REFERENCE TO RELATED APPLICATION

The present application claims priority to and the benefit of the filing date of Chinese Patent Application No. 201620218518.7, filed on Mar. 21, 2016 with the State Intellectual Property Office of China and entitled “Built-in Antenna Structure and Unmanned Aerial Vehicle,” the content of which is hereby incorporated by reference in its entirety.

### FIELD

The present disclosure relates to the technical field of unmanned aerial vehicles, and in particular to a connector, a built-in antenna structure, and an unmanned aerial vehicle using the built-in antenna structure.

### BACKGROUND

In general, an antenna of an unmanned aerial vehicle is exposed to the outside of the body of the vehicle. It is convenient for the exposed antenna to receive a wireless signal. However, an antenna exposed to the outside does not only occupy a space, but also impair the appearance of the unmanned aerial vehicle. Moreover, the antenna tends to have a reduced service life due to a long-term exposure.

### SUMMARY

Accordingly, there is a need to provide a built-in antenna structure for unmanned aerial vehicles, so as to effectively protect the antenna and ensure the reception of signals by the antenna.

In view of this, an object of the present disclosure is to provide a connector, a built-in antenna structure and an unmanned aerial vehicle using the built-in antenna structure. The antenna of the unmanned aerial vehicle is provided in a built-in way to protect the antenna, thereby extending the service life of the antenna, while ensuring the reception of signals by the antenna.

In order to achieve the above-mentioned object, the present disclosure adopts technical solutions as follows.

In one aspect, an embodiment of the present disclosure provides a built-in antenna structure, which is applicable to an unmanned aerial vehicle including a body and a support stand. The support stand is connected with the body and includes a receiving rod. The built-in antenna structure includes a connector, a buffer and an antenna. The antenna is received in the receiving rod. The buffer is received in the receiving rod and wraps the antenna. The connector is disposed between the receiving rod and the body to drive the receiving rod to rotate relative to the body. One end of the antenna protrudes from the connector and is electrically connected with the body.

Preferably, the connector includes a first connecting portion, a second connecting portion and a third connecting portion. The second connecting portion is fixed to the body. The first connecting portion is movably connected with the second connecting portion. The third connecting portion is disposed on the second connecting portion and fixed in a snap-fitted manner with the first connecting portion. The first connecting portion is connected with the receiving rod.

Preferably, the first connecting portion includes a sleeve. The sleeve is provided at a side thereof with two locking portions opposite to each other, and each of the locking portions is provided with a screw hole. In use, a screw can pass through the screw holes of the two locking portions to make the sleeve tightened. The receiving rod is accommodated in and fixed to the sleeve. The receiving rod is made of a fiberglass material.

Preferably, the second connecting portion includes a base seat provided with a fixing hole. The second connecting portion is fixed to the body by means of cooperation of the fixing hole and a fixing member.

Preferably, the connector further includes a rotating shaft. The first connecting portion includes a base provided with a first through hole. The base seat is provided with two fixed portions opposite to each other, and each of the fixed portions is provided with a second through hole. The base is disposed between the two fixed portions, with the first through hole aligned with the second through holes, and the rotating shaft passing through the first through hole and the second through holes. The receiving rod is connected with the base.

Preferably, the base seat is provided with a recess. An edge of the base seat is provided with a notch communicated with the recess. The recess includes two limiting grooves disposed opposite to each other and an accommodating groove disposed opposite to the notch. The two limiting grooves each are communicated with the accommodating groove. One end of the third connecting portion extends straightly to form a protrusion, and the other end of the third connecting portion is provided with a mounting portion on which a spring is mounted. Two opposite sides of the third connecting portion each protrude outward to form a limiting block. The third connecting portion is movably accommodated in the recess of the second connecting portion, with the protrusion protruding from the notch. The mounting portion is mounted in the accommodating groove. The limiting block is movably accommodated in the limiting groove, so as to define a sliding stroke of the third connecting portion in the recess.

Preferably, a bottom of the recess is provided with an opening. The base is provided with a snap-fitting groove. A bottom of the third connecting portion is provided with a snap. The snap passes through the opening and is snap-fitted with the snap-fitting groove. Preferably, the base includes an inclined surface and a horizontal surface, and the inclined surface and the horizontal surface are separated by the snap-fitting groove. In use, the first connecting portion rotates about the rotating shaft to deflect toward one side until the inclined surface abuts against the base seat, so as to make the first connecting portion in a first state; or the first connecting portion rotates about the rotating shaft to deflect toward the other side until the horizontal surface abuts against the base seat, so as to make the first connecting portion in a second state.

The receiving rod has a maximum deflection angle ranging from 18° to 30°. Here, the maximum deflection angle is an angle between a length direction of the receiving rod when the first connecting portion is in the first state and a length direction of the receiving rod when the first connecting portion is in the second state.

In another aspect, an embodiment of the present disclosure further provides an unmanned aerial vehicle, which includes a body and a support stand. The support stand includes a receiving rod. The unmanned aerial vehicle further includes a built-in antenna structure including a connector and an antenna, where the antenna is received in the receiving rod. The connector is disposed between the receiving rod and the body to make the receiving rod connected rotatably with the body. One end of the antenna protrudes from the connector and is electrically connected with a component in the body.

Preferably, the connector includes a first connecting portion, a second connecting portion, a third connecting portion and a rotating shaft. The receiving rod is connected with the first connecting portion. The second connecting portion includes a base seat, with the base seat fixed to the body and provided thereon with a recess. A bottom of the recess is provided with an opening, and an edge of the base seat is provided with a notch communicated with the recess. The recess includes two limiting grooves disposed opposite to each other. One end of the third connecting portion extends to form a protrusion. Two opposite sides of the third connecting portion each protrude outward to form a limiting block. The third connecting portion is movably accommodated in the recess of the second connecting portion, with a spring resiliently sandwiched between the third connecting portion and the second connecting portion, and the protrusion protruding from the notch. The limiting block is accommodated in the limiting groove. The base seat is provided with two fixed portions opposite to each other. The first connecting portion includes a base disposed between the two fixed portions, and the rotating shaft makes the fixed portions and the base connected rotatably. The base is provided with a snap-fitting groove, and a bottom of the third connecting portion is provided with snap, with the snap passing through the opening and snap-fitted with the snap-fitting groove.

Preferably, the base includes an inclined surface and a horizontal surface. The inclined surface and the horizontal surface are separated by the snap-fitting groove. In use, the first connecting portion rotates about the rotating shaft to deflect toward one side until the inclined surface abuts against the base seat, so as to make the first connecting portion in a first state; or the first connecting portion rotates about the rotating shaft to deflect toward the other side until the horizontal surface abuts against the base seat, so as to make the first connecting portion in a second state.

Preferably, the first connecting portion includes a sleeve. The sleeve is provided at a side thereof with two locking portions opposite to each other, and each of the locking portions is provided with a screw hole. In use, a screw can pass through the screw holes of the two locking portions to make the sleeve tightened. The receiving rod is accommodated in and fixed to the sleeve.

In yet another aspect, an embodiment of the present disclosure further provides a connector, which is applicable to a built-in antenna structure of an unmanned aerial vehicle. The unmanned aerial vehicle includes a body and a support stand. The support stand is connected with the body, and includes a receiving rod. The built-in antenna structure further includes a buffer and an antenna. The antenna is received in the receiving rod. The buffer is received in the receiving rod and wraps the antenna. The receiving rod is rotatably connected with the body via the connector. The connector is disposed between the receiving rod and the body to drive the receiving rod to rotate relative to the body. One end of the antenna protrudes from the connector and is electrically connected to the body.

Preferably, the connector includes a first connecting portion, a second connecting portion and a third connecting portion. The first connecting portion includes a sleeve. The sleeve is provided at a side thereof with two locking portions opposite to each other, and each of the locking portions is provided with a screw hole. In use, a screw can pass through the screw holes of the two locking portions to make the sleeve tightened. The receiving rod is accommodated in and fixed to the sleeve. The second connecting portion is fixed to the body. The first connecting portion is movably connected with the second connecting portion. The third connecting portion is disposed on the second connecting portion and fixed in a snap-fitted manner with the first connecting portion.

Preferably, the second connecting portion includes a base seat provided with a fixing hole. The second connecting portion is fixed to the body by means of cooperation of the fixing hole and a fixing member. The connector further includes a rotating shaft. The first connecting portion includes a base provided with a first through hole. The base seat is provided with two fixed portions opposite to each other, and each of the fixed portions is provided with a second through hole. The base is disposed between the two fixed portions, with the first through hole aligned with the second through holes, and the rotating shaft passing through the first through hole and the second through holes. The receiving rod is connected with the base.

Preferably, the base seat is provided with a recess, and an edge of the base seat is provided with a notch communicated with the recess. The recess includes two limiting grooves disposed opposite to each other and an accommodating groove disposed opposite to the notch, and the two limiting grooves each are communicated with the accommodating groove. One end of the third connecting portion extends straightly to form a protrusion, and the other end of the third connecting portion is provided with a mounting portion on which a spring is mounted. Two opposite sides of the third connecting portion each protrude outward to form a limiting block. The third connecting portion is movably accommodated in the recess of the second connecting portion, with the protrusion protruding from the notch, and the mounting portion mounted in the accommodating groove. The limiting block is movably accommodated in the limiting groove so as to define a sliding stroke of the third connecting portion in the recess.

Preferably, a bottom of the recess is provided with an opening. The base is provided with a snap-fitting groove. A bottom of the third connecting portion is provided with a snap, with the snap passing through the opening and snapped-fitted with the snapped-fitting groove.

Preferably, the base includes an inclined surface and a horizontal surface, and the inclined surface and the horizontal surface are separated by the snapped-fitting groove. In use, the first connecting portion rotates about the rotating shaft to deflect toward one side until the inclined surface abuts against the base seat, so as to make the first connecting portion in a first state; or the first connecting portion rotates about the rotating shaft to deflect toward the other side until the horizontal surface abuts against the base seat, so as to make the first connecting portion in a second state.

Beneficial effects achieved by the present disclosure: The built-in antenna structure provided by the embodiment of the present disclosure includes the connector, the buffer and the antenna, where the antenna is received in the receiving rod, the buffer is received in the receiving rod and wraps the antenna, the connector is disposed between the receiving rod and the body so as to drive the receiving rod to rotate relative to the body, and one end of the antenna protrudes from the connector and is electrically connected with the body. With this built-in antenna structure, by making the antenna received in the receiving rod of the unmanned aerial vehicle, the space occupied by the antenna is reduced, and the service life of the antenna and the overall appearance of the unmanned aerial vehicle are improved. Moreover, the receiving rod is rotatable relative to the body, so that the angle of the receiving rod can be adjusted. The receiving rod is made of a fiberglass material, for facilitating the reception of signals by the antenna.

### BRIEF DESCRIPTION OF THE DRAWINGS

FIG. 1 is a schematic perspective view of a built-in antenna structure applicable to an unmanned aerial vehicle, provided by an embodiment of the present disclosure.

FIG. 2 is a schematic perspective view of the built-in antenna structure shown in FIG. 1.

FIG. 3 is an exploded view of a connector of the built-in antenna structure shown in FIG. 2.

FIG. 4 is a schematic view showing the connector, when being in a second state, of the built-in antenna structure shown in FIG. 2.

FIG. 5 is a schematic view showing the connector, when being in a first state, of the built-in antenna structure shown in FIG. 2.

Here, the reference numerals are summarized as follows:

| | |
|---|---|
| support stand | 10 |
| receiving rod | 11 |
| supporting rod | 12 |
| body | 20 |
| built-in antenna structure | 30 |
| connector | 31 |
| buffer | 32 |
| antenna | 33 |
| unmanned aerial vehicle | 200 |
| first connecting portion | 311 |
| second connecting portion | 312 |
| third connecting portion | 313 |
| rotating shaft | 314 |
| base | 315 |
| first through hole | 316 |
| snap-fitting groove | 317 |
| sleeve | 318 |
| base seat | 319 |
| fixed portion | 320 |
| second through hole | 321 |
| opening | 322 |
| snap | 323 |
| inclined surface | 324 |
| horizontal surface | 325 |
| protrusion | 326 |
| recess | 327 |
| notch | 328 |
| fixing hole | 329 |
| locking portion | 330 |
| screw hole | 331 |
| screw | 332 |
| limiting groove | 333 |
| accommodating groove | 334 |
| mounting portion | 335 |
| spring | 336 |
| limiting block | 337 |

### DETAILED DESCRIPTION

The present disclosure will be further described below in details by way of specific embodiments in conjunction with the drawings.

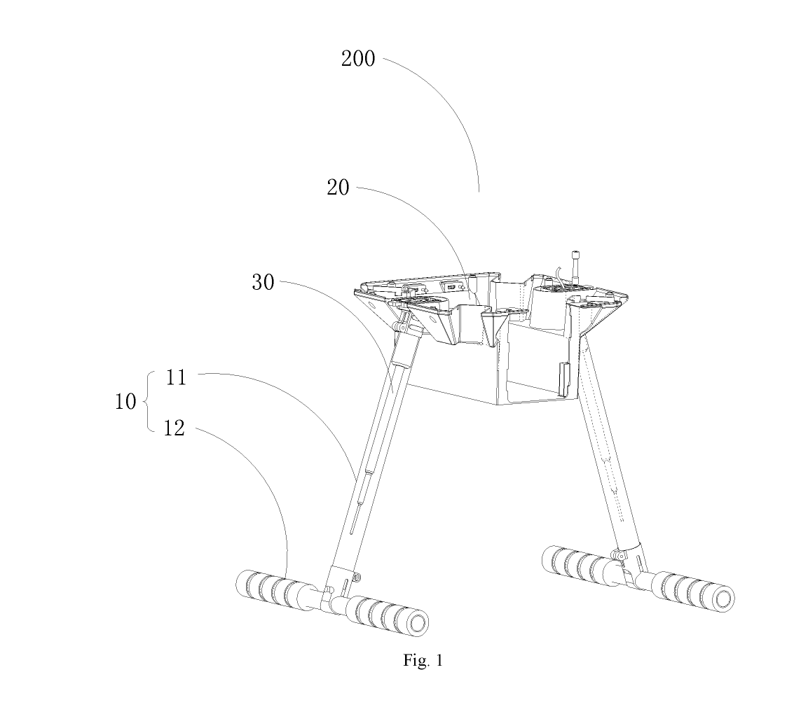

An embodiment of the present disclosure provides a built-in antenna structure 30, which can be applicable to unmanned aerial vehicles, unmanned ships, robots and the like. In the present embodiment, it is introduced by taking a case that such built-in antenna structure is applied to an unmanned aerial vehicle 200 as an example. Referring to FIG. 1, the unmanned aerial vehicle 200 includes a support stand 10 and a body 20. The support stand 10 is connected with the body 20 via the built-in antenna structure 30. Here, the support stand 10 includes a receiving rod 11 and a supporting rod 12. The supporting rod 12 and the receiving rod 11 are connected to present a T shape, that is, the supporting rod 12 and the receiving rod 11 are substantially perpendicular to each other. The supporting rod 12 is configured to provide support for the support stand 10, so that the unmanned aerial vehicle can keep stable on a plane. The built-in antenna structure 30 provided by the embodiment of the present disclosure is received in the receiving rod 11.

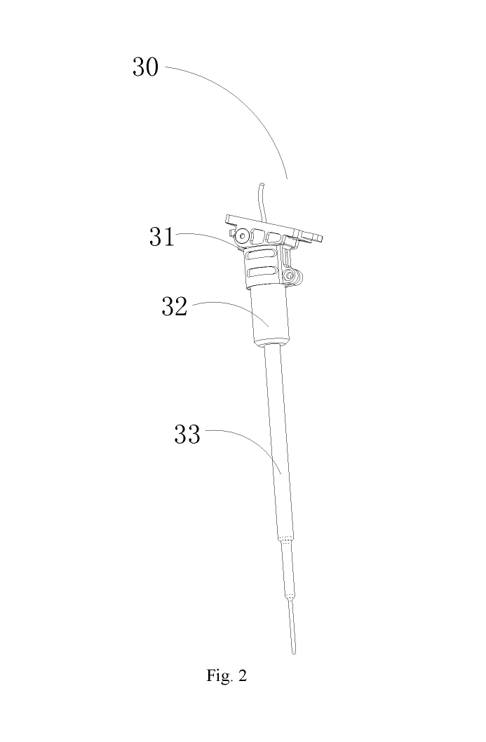

Optionally, reference may be made to FIG. 2, which is a schematic structural view of the built-in antenna structure 30 provided by the embodiment of the present disclosure. The built-in antenna structure 30 includes a connector 31, a buffer 32 and an antenna 33. The buffer 32 is received in the receiving rod 11, and wraps the antenna 33—the buffer 32 wraps only a part of the antenna 33 in the present embodiment—so as to protect the antenna 33, and prevent wobble of the antenna 33 caused by wobble or oscillation of the body when the unmanned aerial vehicle is taking off, descending, landing, flying or otherwise. Such wobble would affect the reception of signals by the antenna 33. Preferably, the buffer 32 takes a form of sleeve, and the buffer 32 is preferably made of a sponge material.

The entire antenna 33 is received in the receiving rod 11. The receiving rod 11 is rotatably connected with the body 20 via the connector 31. One end of the antenna 33 protrudes from the connector 31 and is electrically connected with a component in the body 20. The antenna 33 is received in the receiving rod 11, so that the antenna can be protected from being affected by external environmental factors, and can thus have an extended service life. The receiving rod 11 is connected with the body 20 via the connector 31, and the connector 31 enables the receiving rod 11 to rotate relative to the body 20, so that the antenna 33 built in the receiving rod 11 can also rotate with the receiving rod 11. In this way, an optimum position at which the antenna 33 receives a signal can be obtained by adjusting an angle between the receiving rod 11 and the body 20. Here, the angle is by default an angle of the receiving rod 11 with respect to the vertical direction. In the present embodiment, the receiving rod 11 is rotatable at an angle ranging from 18° to 30°, preferably 18°.

In order to ensure that there is no influence on the ability of the antenna 33 received in the receiving rod 11 in receiving signals, in the present embodiment, the receiving rod 11 is preferably made of a fiberglass material, which is an insulating material and does not affect the reception of signals by the antenna.

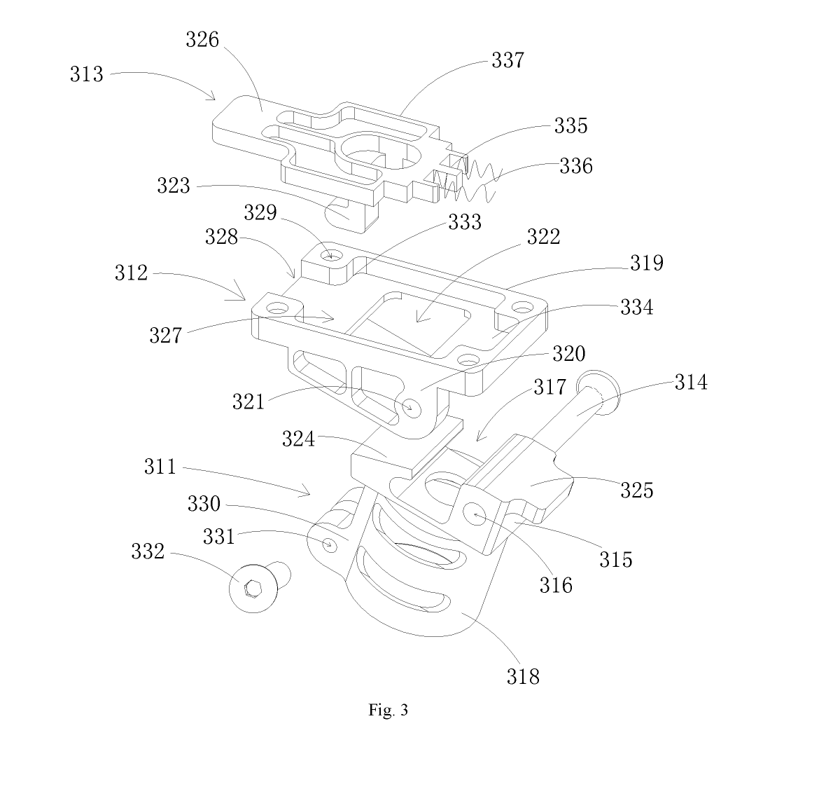

The structure of the connector 31 will be introduced below with reference to FIG. 3, which is an exploded view of the connector 31 of the built-in antenna structure 30 provided by the embodiment of the present disclosure. The connector 31 includes a first connecting portion 311, a second connecting portion 312, a third connecting portion 313 and a rotating shaft 314.

Here, the second connecting portion 312 includes a base seat 319. The base seat 319 is provided at its four corners with fixing holes 329. The second connecting portion 312 may be fixed to the body 20 by means of cooperation of the fixing holes 329 and fixing members (not shown), where the fixing member may be a screw. If the second connecting portion 312 is fixed to the body 20, the fixing members are mounted on the body 20.

The first connecting portion 311 includes a base 315. The base 315 includes an inclined surface 324, a horizontal surface 325 and a snap-fitting groove 317. The inclined surface 324 and the horizontal surface 325 are separated by the snap-fitting groove 317. A first through hole 316 is provided at a portion of the base 315 that is located under the horizontal surface 325. The base seat 319 of the second connecting portion 312 is further provided with two fixed portions 320 opposite to each other. Each of the fixed portions 320 is provided with a second through hole 321. A space between the two fixed portions 320 is configured to accommodate the base 315 of the first connecting portion 311. The first through hole 316 is aligned with the second through holes 321 when the base 315 is located in the space between the two fixed portions 320. By making the rotating shaft 314 pass through the first through hole 316 and the second through holes 321, the first connecting portion 311 and the second connecting portion 312 are fixed together, thereby achieving a rotatable connection between the first connecting portion 311 and the second connecting portion 312.

The base seat 319 of the second connecting portion 312 may be provided with a recess 327. The bottom of the recess 327 is provided with an opening 322, and an edge of the base seat 319 is provided with a notch 328 communicated with the recess 327. The shape of the recess 327 matches the shape of the third connecting portion 313. Optionally, the recess 327 includes two limiting grooves 333 disposed opposite to each other and an accommodating groove 334 disposed opposite to the notch 328. In the present embodiment, each of the limiting grooves 333 is U-shaped, and both the limiting grooves 333 are communicated with the accommodating groove 334.

Optionally, the bottom of the third connecting portion 313 is provided with a snap 323. One end of the third connecting portion 313 extends straightly to form a protrusion 326, and the other end thereof is provided with a mounting portion 335. Further, two opposite sides of the third connecting portion 313 each protrude outward to form a limiting block 337.

Optionally, the snap 323 passes through the opening 322 of the second connecting portion 312 and is snap-fitted with the snap-fitting groove 317 of the first connecting portion 311. Preferably, the number of the snaps 323 is two and the snaps 323 are L-shaped. The protrusion 326 protrudes from the notch 328 to play a role in positioning and guiding, thereby making it convenient for the third connecting portion 313 to be slidably accommodated in the recess 327 of the second connecting portion 312. In the present embodiment, there are two mounting portions 335, each of which is provided therein with a spring 336. The mounting portion 335 is integrally mounted within the accommodating groove 334 in such a manner that one end of the spring 336 abuts against the mounting portion 335 and the other end thereof abuts against an end wall of the accommodating groove 334, so as to provide an elastic recovery effect for the sliding of the third connecting portion 313. Moreover, the limiting block 337 is movably accommodated in its corresponding limiting groove 333, so as to define a sliding stroke of the third connecting portion 313 in the recess 327.

Furthermore, the first connecting portion 311 is connected with the receiving rod 11. Further, the first connecting portion 311 further includes a sleeve 318 disposed on a side of the base 315. The receiving rod 11 is accommodated in and fixed to the sleeve 318 of the first connecting portion 311. Preferably, the receiving rod 11 is fixed to the side of the base on which the sleeve 318 is mounted. The sleeve 318 is provided at a side thereof with two locking portions 330 opposite to each other. Each of the locking portions 330 is provided with a screw hole 331. By making a screw 332 pass through the screw holes 331, the sleeve 318 would be tightened, thereby causing the receiving rod 11 to be fastened within the sleeve 318.

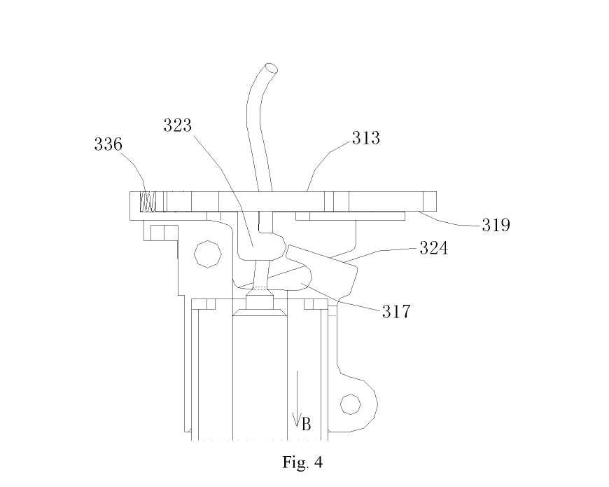

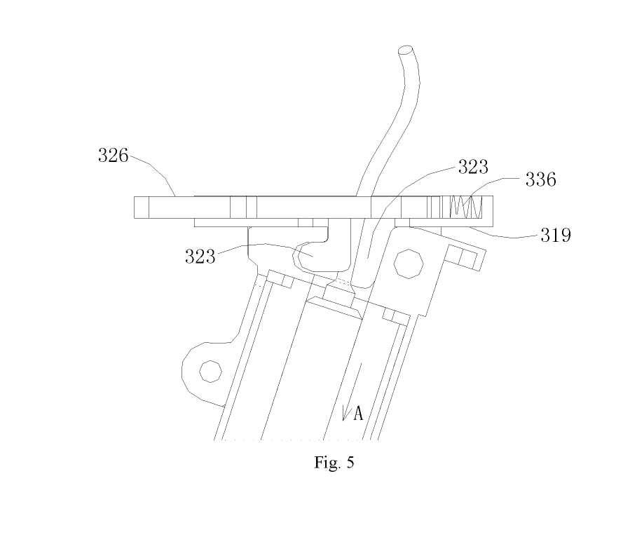

Optionally, the connector 31 provided by the embodiment of the present disclosure makes it possible to realize rotation between the receiving rod 11 and the body 20, by means of cooperation of the first connecting portion 311, the second connecting portion 312 and the third connecting portion 313. Preferably, referring also to FIGS. 4 and 5, if there is a need to adjust the angle of the receiving rod 11, the snap fit between the snap 323 and the snap-fitting groove 317 needs to be released. In this case, the receiving rod 11 should be pulled, and as the second connecting portion 312 is fixed to the body 20 and the first connecting portion 311 is rotatably connected with the second connecting portion 312, the receiving rod 11 may rotate about the rotating shaft 314 with the first connecting portion 311. Optionally, during the rotation of the receiving rod 11, a component of a force applied by a user in a horizontal direction causes the third connecting portion 313 to slide in the recess 327 of the second connecting portion 312, and thus the spring 336 is gradually released. During the rotation of the receiving rod 11, the first connecting portion 311 rotates about the rotating shaft 314 to deflect toward one side (in a direction away from the body) until the inclined surface 324 abuts against the base seat 319. Optionally, in this case, the snap 323 is snap-fitted with the snap-fitting groove 317, and an elastic force applied by the spring 336 to the third connecting portion 313 causes the limiting block 337 to abut against the end wall of the limiting groove 333, and therefore, the position of the receiving rod 11 is fixed, and the first connecting portion 311 is in a first state (as shown in FIG. 5). If there is a need to release the first connecting portion 311 from the first state, the protrusion 326 should be pushed, so that the third connecting portion 313 moves in the recess 327 toward the accommodating groove 334, and therefore, the spring 336 is compressed, and the snap 323 gets away from the snap-fitting groove 317. At this time, the receiving rod 11 may be pulled, so that the first connecting portion 311 rotates about the rotating shaft 314 to deflect toward the other side (in a direction close to the body) until the horizontal surface 325 abuts against the base seat 319, and therefore, the first connecting portion 311 is in a second state (as shown in FIG. 4). Optionally, the maximum angle at which the receiving rod 11 may be deflected, that is, an angle between the receiving rod 11 when the first connecting portion 311 is in the first state and the receiving rod 11 when the first connecting portion 311 is in the second state, depends on the slope of the inclined surface 324 of the first connecting portion 311. It will be readily understood that the larger the slope of the inclined surface 324, the larger the angle at which the receiving rod 11 can be rotated, and vice versa. The angle may range from 18° to 30°, and is preferably 18°.

The maximum angle at which the receiving rod 11 can be deflected is denoted as the maximum deflection angle of the receiving rod 11. Here, the maximum deflection angle is an angle between a length direction of the receiving rod 11 when the first connecting portion 311 is in the first state and a length direction of the receiving rod 11 when the first connecting portion 311 is in the second state. Here, the length direction of the receiving rod 11 is a linear direction from one end of the receiving rod 11 to the other end of the receiving rod 11. Preferably, if the receiving rod 11 has a rod body symmetric about a central axis, the length direction of the receiving rod 11 is a linear direction parallel to the central axis. As shown in FIG. 5, the length direction of the receiving rod 11 is a direction indicated by arrow A shown in FIG. 5, when the first connecting portion 311 is in the first state. As shown in FIG. 4, the length direction of the receiving rod 11 is a direction indicated by arrow B shown in FIG. 4, when the first connecting portion 311 is in the second state. The angle between the direction indicated by arrow A and the direction indicated by arrow B is the maximum deflection angle of the receiving rod 11. In the embodiment of the present disclosure, the maximum deflection angle ranges from 18° to 30°, and is preferably 18°.

To sum up, the built-in antenna structure 30 provided by the embodiment of the present disclosure includes the connector 31, the buffer 32 and the antenna 33, where the buffer 32 is disposed in the sleeve 318 of the connector 31, the buffer 32 wraps the surface of the antenna 33, and the buffer 32 and the antenna 33 are received in the receiving rod 11 of the unmanned aerial vehicle. The connector 31 is disposed between the receiving rod 11 and the body 20 of the unmanned aerial vehicle to drive the receiving rod 11 to rotate relative to the body 20. A portion of the antenna 33 protrudes from the connector 31 and is electrically connected with a component in the body 20. With this built-in antenna structure 30, by making the antenna 33 received in the receiving rod 11 of the unmanned aerial vehicle, the space occupied by the antenna is reduced, and the service life of the antenna and the overall appearance of the unmanned aerial vehicle are improved. Moreover, the receiving rod 11 is rotatable relative to the body 20, so that the angle of the receiving rod 11 can be adjusted. The receiving rod 11 is made of a fiberglass material, for facilitating the reception of signals by the antenna.

In order to make the objects, technical solutions and advantages of the embodiments of the present disclosure more clear, the technical solutions of the embodiments of the present disclosure are described hereinabove clearly and completely in conjunction with the drawings of the embodiments of the present disclosure. It is apparent that the embodiments described are some, but not all of the embodiments of the present disclosure. Generally, the components of the embodiments of the present disclosure, as described and illustrated in the figures herein, may be arranged and designed in a wide variety of configurations.

Therefore, the above detailed description of the embodiments of the present disclosure, as represented in the drawings, is not intended to limit the scope of the present disclosure as claimed, but is merely representative of selected embodiments of the present disclosure. All the other embodiments, obtained by those skilled in the art in light of the embodiments of the present disclosure without any inventive efforts, will fall within the scope of protection of the present disclosure.

It should be noted that, similar reference numerals and letters refer to similar items in the following drawings, and thus once an item is defined in one figure, it would not be further defined or explained in the subsequent figures.

In the description of the present disclosure, it should be indicated that orientation or positional relations indicated by the terms, such as “center”, “up”, “down”, “left”, “right”, “vertical”, “horizontal”, “inner” and “outer”, are based on the orientation or positional relations as shown in the drawings, or the orientation or positional relations at which the product provided by the present disclosure is conventionally placed in use; these terms are only used for the purpose of describing the present disclosure and simplifying the description, rather than indicating or implying that the referred devices or elements must be in a particular orientation or be constructed or operated in a particular orientation, and therefore should not be construed as limiting the present disclosure. In addition, terms such as “first”, “second” and “third” are only used for distinguishing the description, and should not be understood as indicating or implying relative significance

In the description of the present disclosure, it should also be indicated that unless otherwise expressly specified or defined, terms “provide”, “mount”, “couple” and “connect” and their conjugates should be understood in a broad sense. For example, a connection may be a fixed connection, a detachable connection or an integral connection; alternatively, it may be a mechanical connection or an electric connection; alternatively, it may be a direct connection or an indirect connection via an intermediate medium, or may be internal communication between two elements. The specific meanings of the above-mentioned terms in the present disclosure could be understood by those skilled in the art according to specific situations.

1. A built-in antenna structure, applicable to an unmanned aerial vehicle, the unmanned aerial vehicle comprising a body and a support stand, the support stand being connected with the body and comprising a receiving rod, wherein the built-in antenna structure comprises a connector, a buffer and an antenna, the antenna is received in the receiving rod, the buffer is received in the receiving rod and wraps the antenna, the connector is disposed between the receiving rod and the body to drive the receiving rod to rotate relative to the body, and one end of the antenna protrudes from the connector and is electrically connected with the body.

2. The built-in antenna structure according to claim 1, wherein the connector comprises a first connecting portion, a second connecting portion and a third connecting portion, the second connecting portion is fixed to the body, the first connecting portion is movably connected with the second connecting portion, the third connecting portion is disposed on the second connecting portion and fixed in a snap-fitted manner with the first connecting portion, and the first connecting portion is connected with the receiving rod.

3. The built-in antenna structure according to claim 2, wherein the first connecting portion comprises a sleeve, the sleeve is provided at a side thereof with two locking portions opposite to each other, each of the locking portions is provided with a screw hole, a screw can pass through the screw holes of the two locking portions to make the sleeve tightened, the receiving rod is accommodated in and fixed to the sleeve, and the receiving rod is made of a fiberglass material.

4. The built-in antenna structure according to claim 2, wherein the body is provided with a fixing member, the second connecting portion comprises a base seat provided with a fixing hole, and the second connecting portion is fixed to the body by means of cooperation of the fixing hole and the fixing member.

5. The built-in antenna structure according to claim 4, wherein the first connecting portion comprises a base provided with a first through hole, the base seat is provided with two fixed portions opposite to each other, each of the fixed portions is provided with a second through hole, and the base is disposed between the two fixed portions, with the first through hole aligned with the second through holes; the connector further comprises a rotating shaft, with the rotating shaft passing through the first through hole and the second through holes; and the receiving rod is connected with the base.

6. The built-in antenna structure according to claim 5, wherein the base seat is provided with a recess, an edge of the base seat is provided with a notch communicated with the recess, the recess comprises two limiting grooves disposed opposite to each other and an accommodating groove disposed opposite to the notch, and the two limiting grooves each are communicated with the accommodating groove; one end of the third connecting portion extends straightly to form a protrusion, and the other end of the third connecting portion is provided with a mounting portion on which a spring is mounted, two opposite sides of the third connecting portion each protrude outward to form a limiting block, and the third connecting portion is movably accommodated in the recess of the second connecting portion, with the protrusion protruding from the notch, the mounting portion mounted in the accommodating groove, and the limiting block movably accommodated in the limiting groove so as to define a sliding stroke of the third connecting portion in the recess.

7. The built-in antenna structure according to claim 6, wherein a bottom of the recess is provided with an opening, the base is provided with a snap-fitting groove, and a bottom of the third connecting portion is provided with a snap, with the snap passing through the opening and snapped-fitted with the snap-fitting groove.

8. The built-in antenna structure according to claim 7, wherein the base comprises an inclined surface and a horizontal surface, the inclined surface and the horizontal surface are separated by the snap-fitting groove, the first connecting portion can rotate about the rotating shaft to deflect toward one side until the inclined surface abuts against the base seat, so as to make the first connecting portion in a first state, and the first connecting portion can be rotate about the rotating shaft to deflect toward the other side until the horizontal surface abuts against the base seat, so as to make the first connecting portion in a second state.

9. The built-in antenna structure according to claim 8, wherein a maximum deflection angle of the receiving rod ranges from 18° to 30°, with the maximum deflection angle being an angle between a length direction of the receiving rod when the first connecting portion is in the first state and a length direction of the receiving rod when the first connecting portion is in the second state.

10. An unmanned aerial vehicle, comprising a body and a support stand, the support stand comprising a receiving rod, wherein the unmanned aerial vehicle further comprises a built-in antenna structure comprising a connector and an antenna, the antenna is received in the receiving rod, the connector is disposed between the receiving rod and the body to make the receiving rod connected rotatably with the body, and one end of the antenna protrudes from the connector and is electrically connected with a component in the body.

11. The unmanned aerial vehicle according to claim 10, wherein the connector includes a first connecting portion, a second connecting portion, a third connecting portion and a rotating shaft, the receiving rod is connected with the first connecting portion; the second connecting portion comprises a base seat, the base seat is fixed to the body and provided thereon with a recess, a bottom of the recess is provided with an opening, and an edge of the base seat is provided with a notch communicated with the recess, and the recess comprises two limiting grooves disposed opposite to each other; one end of the third connecting portion extends to form a protrusion, and two opposite sides of the third connecting portion each protrude outward to form a limiting block; the third connecting portion is movably accommodated in the recess of the second connecting portion, with a spring resiliently sandwiched between the third connecting portion and the second connecting portion, the protrusion protruding from the notch, and the limiting block accommodated in the limiting groove; the base seat is provided with two fixed portions opposite to each other, the first connecting portion comprises a base disposed between the two fixed portions, and the rotating shaft makes the fixed portions and the base connected rotatably; the base is provided with a snap-fitting groove, and a bottom of the third connecting portion is provided with a snap, with the snap passing through the opening and snap-fitted with the snap-fitting groove.

12. The unmanned aerial vehicle according to claim 11, wherein the base comprises an inclined surface and a horizontal surface, the inclined surface and the horizontal surface are separated by the snap-fitting groove, the first connecting portion can be rotate about the rotating shaft to deflect toward one side until the inclined surface abuts against the base seat, so as to make the first connecting portion in a first state, and the first connecting portion can rotate about the rotating shaft to deflect toward the other side until the horizontal surface abuts against the base seat, so as to make the first connecting portion in a second state.

13. The unmanned aerial vehicle according to claim 10, wherein the first connecting portion comprises a sleeve, the sleeve is provided at a side thereof with two locking portions opposite to each other, each of the locking portions is provided with a screw hole, a screw can pass through the screw holes of the two locking portions to make the sleeve tightened, and the receiving rod is accommodated in and fixed to the sleeve.

14. A connector, wherein the connector is applicable to a built-in antenna structure of an unmanned aerial vehicle, the unmanned aerial vehicle comprises a body and a support stand, the support stand is connected with the body and comprises a receiving rod, the built-in antenna structure further comprises a buffer and an antenna, the antenna is received in the receiving rod, the buffer is received in the receiving rod and wraps the antenna, the receiving rod is rotatably connected with the body via the connector, the connector is disposed between the receiving rod and the body to drive the receiving rod to rotate relative to the body, and one end of the antenna protrudes from the connector and is electrically connected with the body.

15. The connector according to claim 14, wherein the connector comprises a first connecting portion, a second connecting portion and a third connecting portion, the first connecting portion comprises a sleeve, the sleeve is provided at a side thereof with two locking portions opposite to each other, each of the locking portions is provided with a screw hole, a screw can pass through the screw holes of the two locking portions to make the sleeve tightened, and the receiving rod is accommodated in and fixed to the sleeve; the second connecting portion is fixed to the body, the first connecting portion is movably connected with the second connecting portion, and the third connecting portion is disposed on the second connecting portion and fixed in a snap-fitted manner with the first connecting portion.

16. The connector according to claim 15, wherein the body is provided with a fixing member, the second connecting portion comprises a base seat provided with a fixing hole, the second connecting portion is fixed to the body by means of cooperation of the fixing hole and the fixing member; the connector further comprises a rotating shaft, the first connecting portion comprises a base provided with a first through hole, the base seat is provided with two fixed portions opposite to each other, each of the fixed portions is provided with a second through hole, the base is disposed between the two fixed portions, with the first through hole aligned with the second through holes, and the rotating shaft passing through the first through hole and the second through holes; and the receiving rod is connected with the base.

17. The connector according to claim 16, wherein the base seat is provided with a recess, an edge of the base seat is provided with a notch communicated with the recess, the recess comprises two limiting grooves disposed opposite to each other and an accommodating groove disposed opposite to the notch, and the two limiting grooves each are communicated with the accommodating groove; one end of the third connecting portion extends straightly to form a protrusion, and the other end of the third connecting portion is provided with a mounting portion on which a spring is mounted, two opposite sides of the third connecting portion each protrude outward to form a limiting block, and the third connecting portion is movably accommodated in the recess of the second connecting portion, with the protrusion protruding from the notch, the mounting portion mounted in the accommodating groove, and the limiting block movably accommodated in the limiting groove so as to define a sliding stroke of the third connecting portion in the recess.

18. The connector according to claim 17, wherein a bottom of the recess is provided with an opening, the base is provided with a snap-fitting groove, and a bottom of the third connecting portion is provided with a snap, with the snap passing through the opening and snapped-fitted with the snap-fitting groove.

19. The connector according to claim 18, wherein the base comprises an inclined surface and a horizontal surface, the inclined surface and the horizontal surface are separated by the snap-fitting groove, and the first connecting portion can rotate about the rotating shaft to deflect toward one side until the inclined surface abuts against the base seat, so as to make the first connecting portion in a first state, or the first connecting portion is rotate about the rotating shaft to deflect toward the other side until the horizontal surface abuts against the base seat, so as to make the first connecting portion in a second state.
